(19) United States
(12) Patent Application Publication
(10) Pub. No.: US 2002/0095615 A1
(43) Pub. Date: Jul. 18, 2002

(54) Fail safe recovery

(76) Inventors: Jeffrey S. Hastings, Los Altos, CA (US); Ruxiang Wang, Fremont, CA (US)

Correspondence Address: FENWICK & WEST LLP, TWO PALO ALTO SQUARE, PALO ALTO, CA, 94306, US

(21) Appl. No.: 09/976,686

(22) Filed: Oct. 11, 2001

Related U.S. Application Data
(60) Provisional application No. 60/240,615, filed on Oct. 15, 2000.

(51) Int. Cl. G06F 11/08

(52) U.S. Cl. 714/4

(57) ABSTRACT

A consumer electronic device, such as a digital video recorder (DVR), has a media storage storing program code modules and content and a network interface for interfacing with one or more remote servers. Content is stored in a content area, modules for monitoring and controlling the consumer electronic device are stored in a system area, and recovery modules are stored in an error recovery area. The monitoring modules activate the recovery modules in response to the detection of an error. The recovery modules diagnose the error and attempt one or more solutions. One solution attempted by the recovery modules is to activate a network recovery module that downloads and installs new program modules for controlling the consumer electronic device from a remote server.

### CROSS-REFERENCE TO RELATED APPLICATION

This application claims the benefit of U.S. Provisional Application No. 60/240,615, filed Oct. 15, 2000, and hereby incorporated by reference herein.

### BACKGROUND

1. Field of the Invention

This invention pertains in general to a consumer electronic device having a media storage such as a hard drive and in particular to recovering from a failure in such a device.

2. Background Art

Modern consumer electronic devices, such as digital video recorders (DVRs), are more complicated than prior devices. A DVR, for example, typically stores software for controlling the device, as well as the recorded content, on a hard drive or other media. Firmware in the DVR loads the software from the hard drive into random access memory (RAM), and a processor in the DVR executes the instructions contained therein.

Due in part to this extra complexity, modem consumer electronic devices occasionally suffer operational errors. Generally, the errors fall into one of two categories: soft and hard. A “soft” error is an error that can be resolved without replacing a component of the device. Another definition of a soft error is an error that significantly affects the performance of the device yet does not render the device useless. For example, a logic error in program code stored in a modifiable memory is a soft error. Similarly, a corrupt sector on a hard drive or a corrupt value in a random access memory are other examples of soft errors. A “hard” error is an error that renders the device useless and requires replacement (or repair) of a component of the device. For example, a catastrophic failure of a hard drive or other critical physical component is a hard error.

Regardless of the type of error, most consumer electronic devices cannot be repaired by a typical consumer. The consumer electronic devices typically lack sophisticated memory storage, processing, and communications capabilities due to the devices' relatively low costs. Most consumers also do not wish to troubleshoot or “debug” consumer electronic devices. In addition, the devices are too numerous and not valuable enough to justify sending a repair technician to their locations.

Accordingly, it is often necessary for consumers to send the devices to a repair center even when the devices suffer only soft errors. This step is time and labor intensive, as well as costly. Thus, there is a need in the art for a way to repair consumer electronic devices, such as DVRs, suffering from soft errors without requiring the users to perform complicated repair procedures or send the devices in for repair.

### DISCLOSURE OF THE INVENTION

The above need is met by a consumer electronic device that automatically communicates with one or more remote servers in an attempt to diagnose and repair itself. The consumer electronic device, such as a digital video recorder (DVR), has a hard drive or other media storage storing program code modules and content and a network interface for interfacing with a diagnostic server and a software server. Content is stored in a content area of the media storage, modules for monitoring and controlling the consumer electronic device are stored in a system area, and recovery modules are stored in an error recovery area. The monitoring modules detect when to activate the recovery modules. The recovery modules attempt to diagnose the error suffered by the consumer electronic device and attempt one or more solutions in response. One solution performed by the recovery modules is to activate a network recovery module that causes the device to download and execute program modules from a remote server in an attempt to repair the condition that caused the soft error.

### BRIEF DESCRIPTION OF THE DRAWINGS

FIG. 1 is a high-level block diagram illustrating an environment containing a digital video recorder (DVR);

FIG. 2 is a block diagram illustrating a high-level view of the components of the DVR;

FIG. 3 is an illustration of the media storage of FIG. 2 according to an embodiment of the DVR;

FIG. 4 is a flowchart illustrating the operation of the DVR when performing error recovery according to one embodiment; and

FIG. 5 is a flow chart illustrating further details of the “execute recovery procedures” step of FIG. 4.

The figures depict an embodiment of the present invention for purposes of illustration only. One skilled in the art will readily recognize from the following description that alternative embodiments of the structures and methods illustrated herein may be employed without departing from the principles of the invention.

### DETAILED DESCRIPTION OF THE PREFERRED EMBODIMENTS

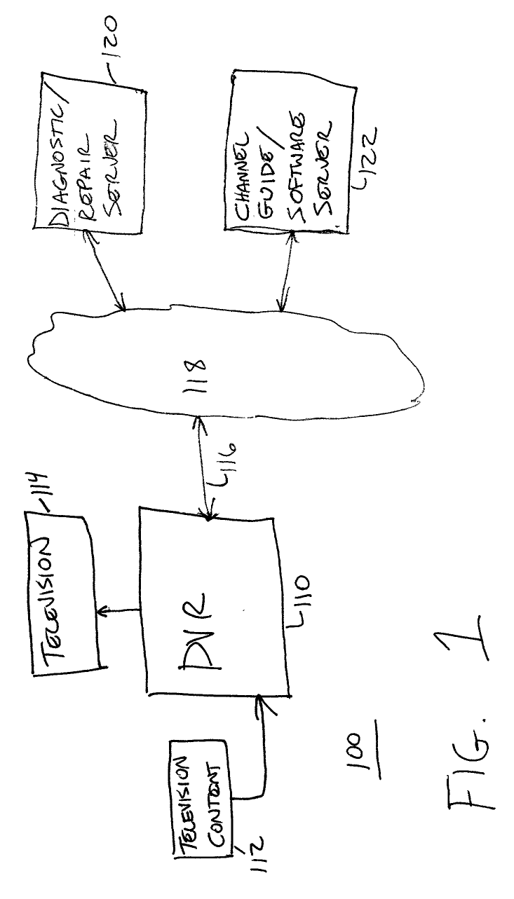

FIG. 1 is a high-level block diagram illustrating an environment 100 containing a digital video recorder (DVR) 110. The DVR 110 is representative of a typical consumer electronic device. As used herein, the phrase “consumer electronic device” refers to a device typically installed in a home or other consumer environment. In addition to DVRs, typical consumer electronic devices include video cassette recorders (VCRs), televisions, personal computers, DVD players, etc. Other forms of consumer electronic devices include cellular telephones, pagers, portable music players, personal digital assistants (PDA), portable computers, portable GPS receivers, etc. The phrase “consumer electronic device” also includes devices not typically utilized by a “consumer,” such as professional-grade devices. In a preferred embodiment, the consumer electronic device is a DVR.

The DVR 110 may be a separate device, or incorporated into other devices such as personal computers, set-top boxes (STBs), and televisions. The DVR 110 preferably receives television content 112 broadcast by a television broadcaster or delivered via a computer network. The phrase “television content” is utilized herein because the DVR 110 is preferably used for storing and viewing television programs. However, the phrase includes any other form of content with which the DVR 110 may be utilized, including, for example, audio, streaming data, etc. The DVR 110 may receive the content via an antenna, a coaxial cable, a direct input, a computer network, etc. The DVR 110 preferably digitizes (if necessary) and stores selected television content 112 and plays it back for display on a television 114.

The DVR 110 is preferably connected via a network connection 116 to the Internet 118 or another network. A diagnostic/repair server 120 (hereafter “diagnostic server”) and a channel guide/software server 122 (hereafter “software server”) are in communication with the DVR 110 via the Internet 118. The DVR 110 can use any known networking technology to access the Internet 118. In one embodiment, the network connection 116 connects the DVR 110 to the Internet 118 via a telephone network. In other embodiments, the network connection 116 utilizes Ethernet or some other networking technology to couple the DVR 110 to the Internet 118. As known in the art, the Internet 118 typically contains one or more servers or networks through which data to/from the DVR 110 may pass. For example, in one embodiment the DVR 110 connects to an Internet Service Provider (ISP) (not shown) that provides Internet access enabling the DVR to communicate with the diagnostic 120 and software 122 servers. In addition, the network topology varies in alternative embodiments and may utilize direct connections or private networks instead of the Internet 118. In one embodiment, for example, the DVR 110 utilizes a modem and telephone network to connect directly to the diagnostic server 120 and/or software server 122. In another embodiment, the DVR 110 receives data from one or more of the servers 120, 122 via the television content 112. For example, the data may be received via a coaxial cable that carries both Internet data and television content, or received via the vertical blanking interval (VBI).

The diagnostic server 120 preferably interacts with the DVR 110 to diagnose and identify likely solutions to problems in the DVR 110. The DVR 110 may contact the diagnostic server 120 in response to a user command and/or automatically (i.e., without human intervention). For example, a user of the DVR 110 may notice that the DVR is not operating normally and cause it to contact the diagnostic server 120 by holding down a particular button for an extended length of time or selecting a particular menu option from an on-screen menu. In another example, the DVR 110 may detect that it is encountering errors while digitizing, storing, and/or playing back the television content and automatically contact the diagnostic server 120 to diagnose the problem 120. The behavior of the diagnostic server 120 is described in more detail below.

The software server 122 preferably provides channel guide data and application software to the DVR 110. The channel guide data are preferably tied to the television content 112 and include information such as program titles, start times, end times, channel information, and other data, such as ratings, descriptions of shows, names of actors and directors, etc. Preferably, the channel guide data are obtained from a commercially available source, such as Tribune Media Services. In a preferred embodiment, the DVR 110 periodically accesses the channel guide data server 126 to download the most recent channel guide data and application software. The DVR 110 can also contact the software server 122 in response to a command from a user or a module within the DVR.

In a typical environment, the diagnostic 120 and software 122 servers are remote from the DVR and may be in simultaneous communication with hundreds or thousands of DVRs. The diagnostic 120 and software 122 servers preferably utilize conventional hardware providing conventional Internet server functionality. In one embodiment, the servers 120, 122 communicate with the DVRs via conventional protocols such as the hypertext transport protocol (HTTP) and/or the file transfer protocol (FTP). The DVRs and the servers 120, 122 preferably exchange messages in conventional formats, such as the hypertext markup language (HTML) and/or extensible markup language (XML). Alternative embodiments of the present invention utilize different protocols and/or languages to communicate.

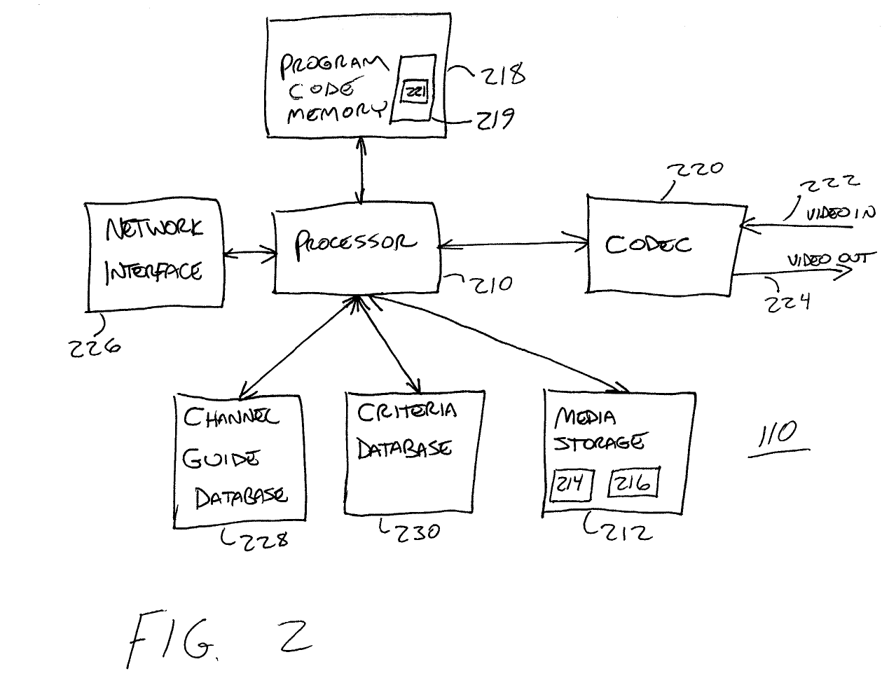

FIG. 2 is a block diagram illustrating a high-level view of the components of the DVR 110. The DVR 110 has a processor 210 for controlling the operation of the DVR. The processor 110 is preferably a commercially-available microprocessor such as a MIPS-based processor from Philips Semiconductors.

The DVR 110 also has a media storage 212. Preferably, the media storage 212 is a high-capacity, rewritable, randomly-accessible recording medium such as a hard drive. The media storage 212 preferably stores digitized television content 214, other data, and program code modules 216 for controlling the operation of the DVR 110. In an alternative embodiment of the DVR 110, the television content 214 and program code modules 216 are stored on separate storage devices. As used herein, the term “module” refers to software computer program code and/or any hardware or circuitry utilized to provide the functionality attributed to the module. Modules are preferably stored in one or more files in the media storage 212. However, the modules may be stored in other locations and/or formats.

It is not uncommon for a hard drive or other media storage 212 to suffer occasional errors. These errors include failures to memory elements (e.g., bad sectors on the hard drive), corruption to files or the file system, file fragmentation, etc. These types of errors can cause the DVR 110 to suffer soft errors.

The DVR 110 also contains a program code memory 218 for holding data and program code modules 216 loaded from the media storage 212 or otherwise stored in the program code memory. In one embodiment, the program code memory 218 includes random-access memory (RAM) and read-only memory (ROM). The program code memory 218 also preferably includes a nonvolatile memory 219, such as Flash RAM, erasable-programmable read-only memory (EPROM), and/or another form of memory that retains state in the absence of power. In one embodiment, the nonvolatile memory 219 is lockable to prevent accidental alteration.

Preferably, program code modules stored in program code memory 218 cause the processor 210 to load other program code modules 216 from the media storage 212 into the program code memory. The processor 110 then executes the program code modules in the program code memory 218. In alternative embodiments of the present invention, the program code modules are stored and/or executed from different locations within the DVR 110.

A network recovery module 221 is preferably stored in the nonvolatile memory 219. In an alternative embodiment, the network recovery module 221 is stored in the ROM or elsewhere in the program code memory 218. The network recovery module 221 preferably contains program code enabling the DVR 110 to contact the diagnostic 120 server, software server 122, and/or other remote server, such as a dedicated server, even when some or all of the other modules in the DVR 110 are missing or corrupt. Preferably, the network recovery module 221 contains an explicit address, such as a toll free telephone number or an internet protocol (IP) address, specifying how to contact the remote server. In addition, the network recovery module 221 contains instructions enabling the DVR 110 to contact the remote server at the explicit address and download and execute modules from the server. Thus, the network recovery module 221 enables the DVR 110 to engage in a recovery procedure even when the DVR has suffered significant errors with the modules stored in the media storage 212.

The DVR 110 preferably contains a CODEC 220 for receiving the television content 112 or other video input signals from the video input 222 and outputting video signals to the television 114 or other display device via the video output 224. Preferably, the CODEC 220 digitizes the received television content and optionally compresses the content using Moving Pictures Expert Group (MPEG) compression. The digitized television content 214 is stored in the media storage 212. The CODEC 220 also preferably converts the digitized television content 214 into analog signals and provides the analog signals to the video output 224. Those of skill in the art will recognize that the functionality of the CODEC 220 can be optionally disabled depending upon the embodiment of the present invention. For example, the CODEC 220 can receive digital signals from an upstream digital device and/or provide digital output signals to a downstream digital device.

A network interface 226 allows the DVR 110 to send and receive data to and from remote servers via the network connection 116. The type of network interface depends upon the type of network connection utilized by the DVR 110. The network interface 226 might include, for example a modem or an Ethernet card.

The DVR 110 preferably stores channel guide data received from the software server 122 via the network interface 226 in a channel guide database 228. In a preferred embodiment of the DVR 110, the channel guide database 228 is stored in the media storage 212, although alternative embodiments store the database in another location.

The DVR 110 preferably stores criteria for selecting programming from the channel guide database 228 in a criteria database 230. Preferably, the user uses a user interface to specify criteria identifying programs for the DVR 110 to record. For example, the user may specify the criteria by selecting the program from an electronic program guide (EPG), manually specifying that the DVR 110 record from a certain channel at a certain time, specifying that the DVR 110 record any program containing a certain word in its title, or by some combination or variation of these techniques. When the criteria in the criteria database 230 match a program contained in the channel guide database 228, the processor 210 and program code modules cause the DVR 110 to record the program. In a preferred embodiment of the DVR 110, the criteria database 230 is stored in the media storage 212, although alternative embodiments store the database in another location.

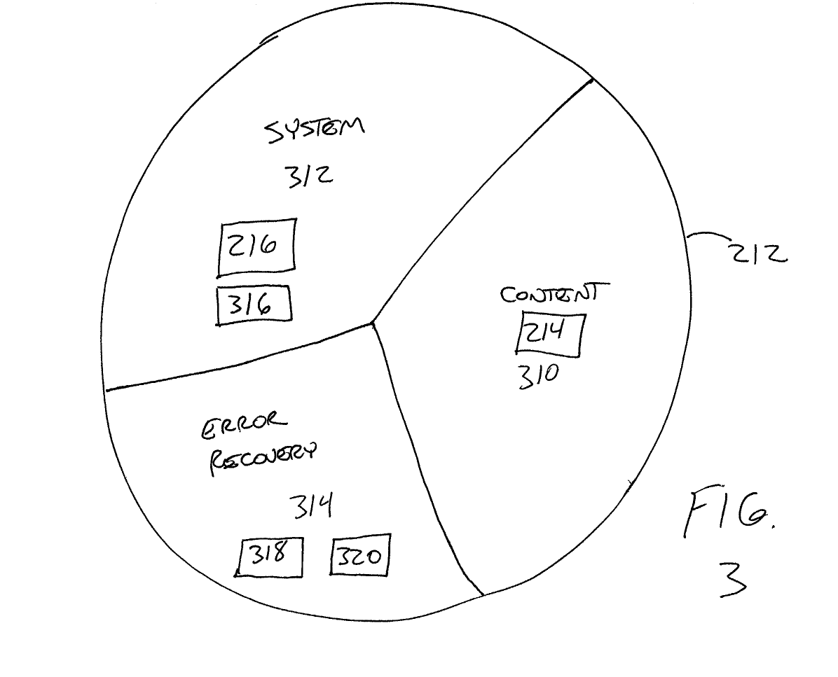

FIG. 3 is an illustration of the media storage 212 of FIG. 2 according to an embodiment of the DVR 110. The media storage 212 has three main areas: content 310, system 312, and error recovery 314. Preferably, these areas are stored in different partitions, so that one area can be formatted or otherwise modified without affecting the other areas. In an alternative embodiment, the three areas are stored in a single partition or in another configuration. In FIG. 3, the media storage 212 is represented as a platter of a hard drive and the three areas are illustrated in different sectors of the platter. Those of ordinary skill in the art will recognize that FIG. 3 illustrates a logical representation of the media storage 212 and is not intended to represent the physical layout of data.

The content area 310 preferably stores the digitized television content 214. In one embodiment, the television content area 310 also stores the channel guide database 228 and criteria database 230. In an alternative embodiment, these two databases 228, 230 are stored in other areas or in dedicated partitions.

The system area 312 preferably stores the program code modules 216 for controlling the operation of the DVR 110. In one embodiment of the DVR 110, the system area 312 also stores program code modules 316 for monitoring the operation of the DVR and detecting whether to start the error recovery process (referred to as “monitoring modules”). In an alternative embodiment, all or a portion of the monitoring modules 316 are stored in the nonvolatile memory 219.

The error recovery area 314 preferably stores program code modules 318 (referred to as “recovery modules”) and data modules 320 for repairing or otherwise recovering from soft errors in the DVR 110. In one embodiment, the error recovery area 314 is locked, hidden, encrypted, or otherwise protected from alteration. Therefore, there is a high probability that the recovery modules 318 in the error recovery area 314 are intact and uncorrupted, despite any errors suffered by the DVR 110. In another embodiment, at least a portion of the recovery 318 modules are stored in the nonvolatile memory 219 to likewise ensure that an uncorrupted version of the modules are present in the DVR 110.

The data modules 320 in the error recovery area 314 preferably include an executable backup copy of the program code modules 216 for controlling the operation of the DVR 110. This backup copy can be utilized as a direct replacement should an error occur in the program code modules 216 in the system area 312. The data modules 320 preferably can also be used as backup copies of the individual files that comprise the program code modules 216 for controlling the operation of the DVR.

The recovery modules 318 in the error recovery area 314 preferably implement procedures for diagnosing and/or repairing soft errors occurring in the DVR 110. In order to implement the recovery procedures, the recovery modules 318 preferably contain modules for determining whether to activate the network recovery module 221. In one embodiment, the recovery modules 318 also include modules for interacting with the diagnostic 120 and software 122 servers, modules for reformatting the system 312 and/or television content 310 areas, modules for scanning and verifying the integrity of individual files in the system 312 and/or television content 310 areas, and modules for re-installing appropriate program code modules from the backup copies held in the data modules 320 or downloaded from the diagnostic 120, software 122, or other remote servers.

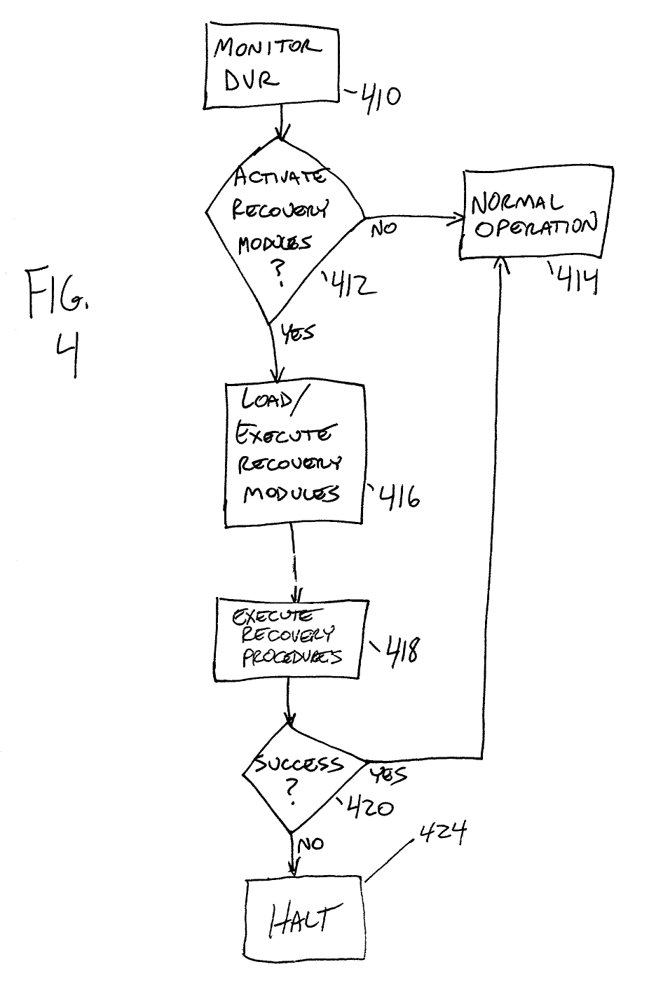

FIG. 4 is a flowchart illustrating the operation of the DVR 110 when performing error recovery according to an embodiment of the present invention. FIG. 4 represents only one of many possible variations of the error recovery behavior and those of ordinary skill in the art will recognize that alternative embodiments may omit illustrated steps, perform the steps in different orders, and/or add additional steps not shown in FIG. 4.

Initially, the monitoring modules 316 are active and monitoring the state of the DVR 110. The monitoring modules 316 determine 412 whether to activate the recovery modules 318. This determination is made in response to the state of the DVR 110. For example, in one embodiment the monitoring modules 316 are activated when the DVR 110 is booted (i.e., powered-up) and the monitoring modules activate the recovery modules 318 if the DVR's power button (not shown) is pressed for a certain amount of time, e.g. 10 seconds. In another embodiment, the monitoring modules 316 are always active while the DVR 110 is active. For example, in one embodiment the monitoring modules 316 are executed as a background process and track the operations of the other modules. If certain conditions are detected, such as a hard drive read/write error or a software crash or lockup, the monitoring modules 316 automatically activate the recovery modules 318. In an additional embodiment, the DVR 110 activates the monitoring modules 316 in response to certain other conditions and the monitoring modules 316 then decide whether the activate the recovery modules 318.

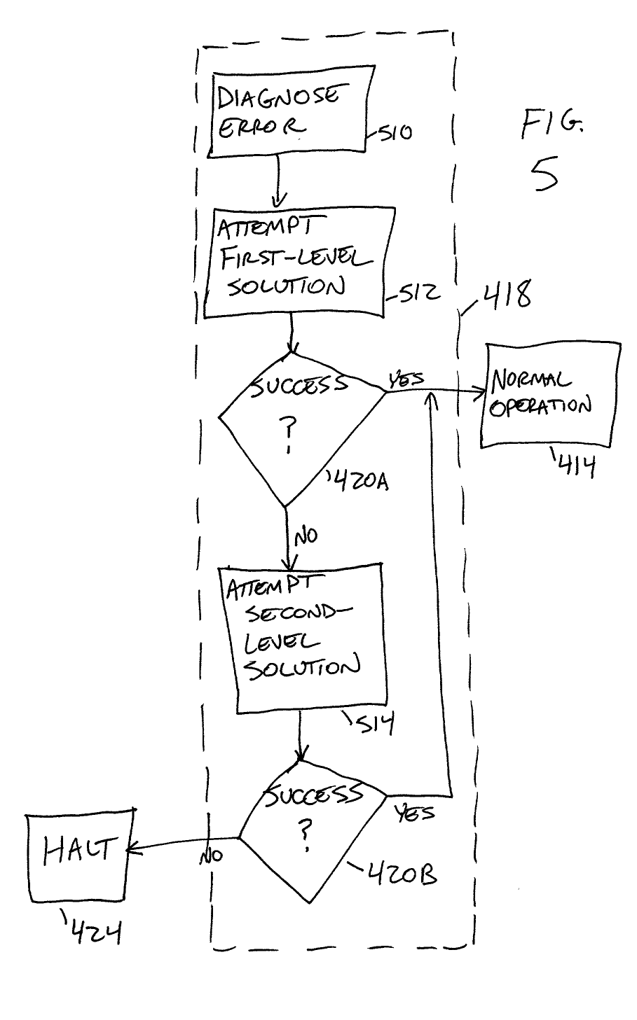

If 412 the monitoring modules 316 do not activate the recovery modules 318, then the DVR 110 resumes (or continues) 414 normal operation. Otherwise, the DVR 110 preferably loads 416 and executes the recovery modules 318. The recovery modules 318 preferably execute the set of recovery procedures described below with respect to FIG. 5. If 420 the recovery procedures are successful, the DVR 110 resumes 414 normal operation. If 420 the recovery procedures are not successful, then the DVR 110 is unable to self-recover from the soft error. If the DVR is still capable of operation, one embodiment of the DVR 110 continues to operate (this condition is not shown in FIG. 4). If, however, the DVR 110 cannot operate normally, one embodiment halts 424 operation.

If possible, the DVR 110 preferably displays information on the television 114 indicating the DVR's status. This information can take the form of text messages explaining the actions being performed by the DVR 110, such as “Contacting Server,” “Downloading Software,” “Fail Safe Recovery In Progress,” or “Operation Halted Due to Unrecoverable Error.” The DVR 110 can also indicate steps for a user to perform, such as calling a telephone service hotline or delivering the unit to a specific service center. In another embodiment, the DVR 110 controls the display of light emitting diodes (LED) (not shown) or another display on the DVR itself to indicate its status. For example, the DVR 110 can cause the LED to blink a certain number of times to indicate an error code or function being performed by the DVR.

FIG. 5 is a flow chart illustrating details of the “execute recovery procedures” step 418 of FIG. 4. As with FIG. 4, FIG. 5 represents only one of many possible variations of the error recovery behavior and those of ordinary skill in the art will recognize that alternative embodiments may omit illustrated steps, perform the steps in different orders, and/or add additional steps not shown in FIG. 5.

The recovery procedures preferably attempt to diagnose 510 the error or errors suffered by the DVR 110. In one embodiment, the recovery modules 318 contain program logic for identifying common errors. For example, one or more of the files in the content 310 and/or system 312 area may be corrupt. The file system itself may also be corrupt. Another possible error is abnormal fragmentation of files in the content 310 or system 312 areas. Still another possible error is corruption to program modules or data in the system area 312 that is undetectable at run-time and then causes further errors to the DVR 110 when the program modules are executed.

In one embodiment, the recovery procedures utilize the network interface 226 to communicate with the diagnostic server 120 in an attempt to diagnose 510 the source of the error. For example, the recovery modules 318 may send the diagnostic server 120 log files, core dump files, program variables, user provided data, etc. The diagnostic server 120 analyzes these data against known sources of error to identify the error. In one embodiment, the diagnostic server 120 saves information about errors reported by the DVRs 110 for later analysis.

In one embodiment, the recovery procedures attempt 512 a first-level solution in response to the diagnosed error. In general, the first-level solution attempts to recover from the error by performing minor repairs on the DVR 110. In an alternative embodiment, the recovery procedures do not attempt the first-level solution and instead immediately attempt 514 the second-level solution described in more detail below.

The particular first-level solution attempted by the recovery procedures depend upon the embodiment of the DVR 110 and/or the diagnosed error. In one embodiment, the DVR 110 receives the first-level solution from the diagnostic server 120. If a file in the system area 312 is corrupt, a possible first-level solution performed by the recovery procedures is to replace the corrupt file with a clean copy of the file from the data modules 320 in the error recovery area 314. If the file system is corrupt, a possible first-level solution is to rebuild the file system. If files are abnormally fragmented, a possible first-level solution is to defragment the files. Different embodiments of the DVR 110 may perform 512 different or multiple first-level solutions in response to detected or diagnosed errors. Certain diagnosed errors may not have first-level solutions, in which case the recovery procedures may skip step 512. In addition, in one embodiment there are default first-level solutions that are performed for one or more different or undiagnosed errors.

If the first-level solution is successful 420A (this step is identified with reference numeral “420A” because it is essentially a substep of step 420 illustrated in FIG. 4), then the DVR 110 preferably resumes normal operation 414. Otherwise, the recovery procedures preferably attempt 514 a second-level solution. In general, a second-level solution is a major repair of the DVR 110.

The specific second-level solution depends upon the embodiment of the DVR 110 and/or the diagnosed error. In one embodiment, a second-level solution is to boot the DVR utilizing the backup copies of the program modules stored in the data modules 320 in the error recovery area 314. Another second-level solution is to activate the network recovery module 221 in the nonvolatile memory 219. The network recovery module 221 preferably contacts the remote server and downloads a small executable program module. The network recovery module 221 preferably reboots the DVR 110 and executes this program module, which then causes the DVR to reformat the media storage 212, rebuild the file system, and download replacement program modules from the software server 122 or another remote server. In another embodiment, the second-level solution is to reformat the content 310 and/or system 312 areas and then install the replacement copies of the program modules from the data modules 320 in the error recovery area 314.

Different embodiments of the DVR 110 may attempt different or additional second-level solutions. In addition, embodiments of the DVR 110 may attempt two or more of the second-level solutions. For example, one embodiment of the DVR 110 first attempts to boot the DVR from the backup copy of the program modules in the error recovery area 314 and activates the network recovery module 221 only if the backup copy fails to cure the error. If the second-level solution is successful 420B, then the DVR 110 preferably resumes normal operation 414. Otherwise, the DVR 110 preferably either continues operation, if possible, or halts 424.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A consumer electronic device, comprising:
a network interface for communicating with a remote server; and a media storage for storing program code modules for controlling an operation of the consumer electronic device, the program code modules comprising:
an error recovery module for utilizing the network interface to
communicate with the remote server and attempt to recover from an error experienced by the consumer electronic device; and
a monitoring module for monitoring the operation of the consumer
electronic device and determining whether to activate the error recovery module.

2. The consumer electronic device of claim 1, wherein the consumer electronic device is a digital video recorder.

3. The consumer electronic device of claim 1, wherein the media storage comprises:
a system area for storing the monitoring module and a control module for
controlling the operation of the consumer electronic device; and
an error recovery area for storing the error recovery module.

4. The consumer electronic device of claim 3, wherein the error recovery area comprises:
data modules for storing backup copies of the monitoring and control
modules;
wherein the error recovery module is adapted to restore the monitoring and/or
control modules from the data modules to the system area.

5. The consumer electronic device of claim 1, wherein the error recovery module comprises:
a network recovery module for downloading and installing new program code
modules from the remote server.

6. The consumer electronic device of claim 1, wherein the network interface is adapted to communicate with a diagnostic server and wherein the error recovery module further comprises:
a diagnostic module for communicating with the diagnostic server to diagnose
the error experienced by the consumer electronic device.

7. The consumer electronic device of claim 1, wherein the error recovery module is adapted to:
attempt a first-level solution to the error; and responsive to a failure of the first-level solution, attempt a second-level
solution to the error.

8. The consumer electronic device of claim 7, wherein the first-level solution comprises attempting to recover from the error by performing a minor repair on the program code modules stored by the media storage.

9. The consumer electronic device of claim 7, wherein the second-level solution comprises activating a network recovery module for downloading program code modules from a remote server and installing the program code modules on the media storage.

10. The consumer electronic device of claim 1, further comprising:
a nonvolatile memory for storing the monitoring and/or error recovery
modules.

11. The consumer electronic device of claim 1, further comprising:
a status module for displaying a status of the error recovery module.

12. A method of attempting to resolve an error suffered by a consumer electronic device, comprising the steps of:
attempting to diagnose the error; and attempting a solution to the diagnosed error suffered by the consumer
electronic device, the attempt performed automatically responsive to a detection of the error.

13. The method of claim 12, wherein the step of attempting a solution to the diagnosed error comprises the step of:
attempting to execute backup copies of program code modules for controlling
the consumer electronic device stored on a media storage associated with the device.

14. The method of claim 12, wherein the step of attempting a solution to the diagnosed error comprises the step of:
downloading program code modules for controlling the consumer electronic
device from a remote server in communication with the consumer electronic device.

15. The method of claim 12, wherein the step of attempting a solution to the diagnosed error comprises the steps of:
attempting a first-level solution to the error; and responsive to a failure of the first-level solution, attempting a second-level
solution to the error.

16. The method of claim 15, wherein the step of attempting a first-level solution to the error comprises the step of:
attempting to recover from the error by performing minor repairs on a media
storage associated with the consumer electronic device.

17. The method of claim 15, wherein the step of attempting a second-level solution to the error comprises the step of:
activating a network recovery module for downloading program code modules
from a remote server and installing the program code modules on a media storage associated with the consumer electronic device.

18. The method of claim 12, further comprising the step of:
displaying a status of the consumer electronic device.

19. A computer program product comprising:
a computer-usable medium having computer-readable code embodied therein
for controlling an operation of a consumer electronic device having a network interface, the computer program product comprising:
an error recovery module for utilizing the network interface to
communicate with a remote server and attempt to recover from an error experienced by the consumer electronic device; and
a monitoring module for monitoring the operation of the consumer
electronic device and determining whether to activate the error recovery module.

20. The computer program product of claim 19, wherein the computer-usable medium comprises:
a system area for storing the monitoring module and a control module for
controlling the operation of the consumer electronic device; and
an error recovery area for storing the error recovery module.

21. The computer program product of claim 20, wherein the error recovery area comprises:
data modules for storing backup copies of the monitoring and control
modules;
wherein the error recovery module is adapted to restore the monitoring and/or
control modules from the data modules to the system area.

22. The computer program product of claim 19, wherein the error recovery module comprises:
a network recovery module for downloading and installing new program code
modules from the remote server.

23. The computer program product of claim 19, wherein the network interface communicates with a diagnostic server and wherein the error recovery module further comprises:
a diagnostic module for communicating with the diagnostic server to diagnose
the error experienced by the consumer electronic device.

24. The computer program product of claim 19, wherein the error recovery module is adapted to:
attempt a first-level solution to the error; and responsive to a failure of the first-level solution, attempt a second-level
solution to the error.

25. The computer program product of claim 24, wherein the first-level solution comprises attempting to recover from the error by performing minor repairs on the computer-readable code for controlling the operation of the consumer electronic device.

26. The computer program product of claim 24, wherein the second-level solution comprises activating a network recovery module for downloading program code modules from a remote server and installing the program code modules on the computer-usable medium.

27. The computer program product of claim 19, wherein the computer-usable medium further comprises:
a nonvolatile memory for storing at least a portion of the monitoring and/or
error recovery modules.
